(19) United States
(12) Patent Application Publication
(10) Pub. No.: US 2008/0288568 A1
(43) Pub. Date: Nov. 20, 2008

(54) Low power Fast Hadamard transform

(76) Inventor: Hsieh S. Hou, Rancho Palos Verdes, CA (US)

Correspondence Address: Carole A. Mulchinski , M1/040;The Aerospace Corporation,, 2350 East El Segundo Boulevard, El Segundo, CA, 90245, US

(21) Appl. No.: 11/803,652

(22) Filed: May 14, 2007

(51) Int. Cl. G06F 17/14

(52) U.S. Cl. 708/404

(57) ABSTRACT

Fast Hadamard transforms (FHT) are implemented using a pipelined architecture having an input stage, a processing stage, and an output stage, the FHT having a single internal loop back between the output stage and the input stage, the processing stage having at least one Hadamard processing unit. The FHT implementations provided both forward and inverse transformations, and, lossless normalized and lossfull unnormalized transformations, while the FHT implementation includes only multiplexers, demultiplexer, latches, and shift registers, and while, the processing unit stage includes processing units using only shift registers and effective adders, for fast, low power, and low weight Hadamard transform implementations.

### STATEMENT OF GOVERNMENT INTEREST

This invention was made with Government support under contract No. FA8802-04-C-0001 awarded by the Department of the Air Force. The Government has certain rights in the invention.

### FIELD OF THE INVENTION

The invention relates to the field of transforms applied to data sets. More particularly, the present invention relates to Fast Hadamard transforms.

### BACKGROUND OF THE INVENTION

The Hadamard transform (HT) has been used in the Direct Sequence Code Division Multiple Access (DS-CDMA) and Multiple Carrier Code Division Multiple Access (MC-CDMA) spread spectrum communication systems for wireless communications. For examples, HT is used in the noncoherent demodulator or block code decoder in DS-CDMA, and in the spreading of user signals in MC-CDMA. In the wireless communications industry, the power, weight, and volume of electronic components are primary design considerations.

A normalized Hadamard transform is represented by the matrix H. Th matrix is a square normalized orthogonal matrix. The normalized Hadamard transform is also known as the Hadamard or Walsh Hadamard transform. Neglecting a normalization factor 1/√N, the elements of an N by N Hadamard matrix are either 1 or −1, and each row of the Hadamard matrix is orthogonal to the other rows. The Hadamard transform without the normalization factor, is called the unnormalized Hadamard transform that is represented by the matrix U.

The relationship between the normalized Hadamard transform and the unnormalized Hadamard transform is H=U/√N. When the (−1) elements of the unnormalized Hadamard matrix are converted into 0, the rows of the unnormalized Hadamard matrix are called Walsh sequences.

For example, the unnormalized 8×8 Hadamard transform is given by the U₈ unnormalized Hadamard matrix.

$${U}_{8} = [ \begin{matrix}1 & 1 & 1 & 1 & 1 & 1 & 1 & 1 \\ 1 & - 1 & 1 & - 1 & 1 & - 1 & 1 & - 1 \\ 1 & 1 & - 1 & - 1 & 1 & 1 & - 1 & - 1 \\ 1 & - 1 & - 1 & 1 & 1 & - 1 & - 1 & 1 \\ 1 & 1 & 1 & 1 & - 1 & - 1 & - 1 & - 1 \\ 1 & - 1 & 1 & - 1 & - 1 & 1 & - 1 & 1 \\ 1 & 1 & - 1 & - 1 & - 1 & - 1 & 1 & 1 \\ 1 & - 1 & - 1 & 1 & - 1 & 1 & 1 & - 1\end{matrix} ]$$

The eight Walsh sequences corresponding to an unnormalized 8×8 Hadamard matrix is given by the Walsh sequences.

$$Walsh Sequences$$

$$\begin{matrix}1 & 1 & 1 & 1 & 1 & 1 & 1 & 1 \\ 1 & 0 & 1 & 0 & 1 & 0 & 1 & 0 \\ 1 & 1 & 0 & 0 & 1 & 1 & 0 & 0 \\ 1 & 0 & 0 & 1 & 1 & 0 & 0 & 1 \\ 1 & 1 & 1 & 1 & 0 & 0 & 0 & 0 \\ 1 & 0 & 1 & 0 & 0 & 1 & 0 & 1 \\ 1 & 1 & 0 & 0 & 0 & 0 & 1 & 1 \\ 1 & 0 & 0 & 1 & 0 & 1 & 1 & 0\end{matrix}$$

The matrix elements in each row of the unnormalized Hadamard matrix, which are either a positive one or a negative one, are used to multiply, that is, weight, the corresponding input samples in transform process. The transformed output of an unnormalized Hadamard transform is the sum of the weighted input. To perform an unnormalized Hadamard transform on N samples based on the operations given in matrix U, the parallel pipeline requires N accumulators with each accumulator performing (N−1) additions. Some of the prior Hadamard transforms were designed having N=8. Taking into account the normalization factor, the transformed output of the unnormalized Hadamard transform is √N times of that of the normalized Hadamard transform. The transform input power is the sums of each squared input sample values. The transformed power is the sums of each squared transform output sample values. For the same input, the transformed power of the unnormalized Hadamard transform is N times of the transformed power of the normalized Hadamard transform, which is equal to the transform input power.

The fast Hadamard transform (FHT) has been used for high speed applications. The prior art fast Hadamard transform (FHT) has a parallel-pipelined architecture very similar to that of the fast Fourier transform (FFT). The FHT parallel-pipelined architecture for the unnormalized Hadamard transform may have eight inputs and consists of three processing stages. The FHT parallel-pipelined architecture for the normalized Hadamard transform of eight inputs exhibits a structure of multipliers that must be used to take into account the normalization factor, for example, √8. The FHT for the unnormalized Hadamard transform of eight inputs, is constructed based on the following H₂ₙ recursive algorithm for the normalized Hadamard transform for n=2^{k} where (k=0, 1, 2, . . .). The H₂ₙ recursive algorithm defines H₂ and H₄ recursive algorithms.

$${H}_{2 n} = \frac{1}{\sqrt{2}} [ \begin{matrix}{H}_{n} & {H}_{n} \\ {H}_{n} & - {H}_{n}\end{matrix} ] = \frac{1}{\sqrt{2}} [ \begin{matrix}{I}_{n} & {I}_{n} \\ {I}_{n} & - {I}_{n}\end{matrix} ] [ \begin{matrix}{H}_{n} & 0 \\ 0 & {H}_{n}\end{matrix} ]$$

$${H}_{2} = \frac{1}{\sqrt{2}} [ \begin{matrix}1 & 1 \\ 1 & - 1\end{matrix} ]$$

$${H}_{4} = \frac{1}{\sqrt{2}} [ \begin{matrix}{I}_{2} & {I}_{2} \\ {I}_{2} & - {I}_{2}\end{matrix} ] [ \begin{matrix}{H}_{2} & 0 \\ 0 & {H}_{2}\end{matrix} ]$$

The recursive algorithm for the unnormalized Hadamard transform is obtained by replacing the H with U and by setting the normalization factor √2 into 1 in the recursive algorithm for the normalized Hadamard transform.

The unnormalized Hadamard transform used in CDMA systems is a square orthogonal matrix of the dimension 64 by 64. A normalization factor of 8, which is the square root of 64, is used to divide all the elements for equating the input and output power of the Hadamard transform. In the forward link of a CDMA system, the scrambled coded symbols are exclusive-Ored with a row of a dimension-64 Walsh sequence. This process known as Walsh covering ensures that each user within a cell is orthogonal to every other user within the cell, assuming that different rows of the 64 Walsh sequences are used for each user. The symbol stream then modulates a carrier using Binary-Phase-Shift Keying (BPSK) modulation with Quadrature-Phase-Shift Keying (QPSK) spreading. In the reverse link of a CDMA system, the despread symbol stream is the input of the 64-ary noncoherent demodulator and block decoder. The block decoder then performs a correlation with each row of the dimension 64 unnormalized Hadamard matrix. The correlation function with each row is the same as performing an inverse unnormalized Hadamard transform. The inverse Hadamard transform matrix is the same as the forward Hadamard transform matrix disregarding the different normalization factor in the unnormalized Hadamard transform matrix. The FHT used in the 64-ary CDMA noncoherent demodulator has the similar form of the structure for N=8.

Another application of the Hadamard transform is for redistributing multiple-channel input data to multiple CDNA channels. In such applications, the output data after passing through the Hadamard transform are more evenly distributed over all the channels when the input data from the multiple channels are uncorrelated. Conventional Fast Hadamard transforms can be by definition an Nth order normalized Hadamard transform that requires N(N−1) additions and N multiplications. The implementation of using N accumulators and N multipliers disadvantageously increases power consumption and chip area.

The disadvantages of the prior HT parallel pipeline design are that the unnormalized Hadamard transform uses a large number of N accumulators with each accumulator performing (N−1) additions and that the normalized Hadamard transform needs additional number of N multipliers. The disadvantages of the prior FHT parallel pipeline design are that the unnormalized Hadamard transform uses a large number of log₂(N) stages with each stage having N adders. Another disadvantage is that the normalized Hadamard transform needs additional N multipliers. To avoid using any multipliers, the unnormalized Hadamard transform is repetitively used in many applications. But the transformed power of the unnormalized Hadamard transform is disadvantageously N times larger than the transform input power. A VLSI layout of multiple processing stages according to the prior FHT parallel-pipelined architecture for both the unnormalized and normalized Hadamard transforms requires a large chip area with the total adders and multipliers consuming a considerable amount of power. In chip area saving designs, an address generator and random access memory must be used for folding the multiple stages into one. The chip area saving designs slows down the processing speed due to frequent memory accesses. Moreover, for integer input data, none of the prior FHT is lossless in that the inverse FHT cannot completely recover the integer input data. These and other disadvantages are solved or reduced using the invention.

### SUMMARY OF THE INVENTION

An object of the invention is to provide a fast Hadamard transform having reduced power.

Another object of the invention is to provide a fast Hadamard transform having reduced weight.

Yet another object of the invention is to provide a fast Hadamard transform using a parallel-pipeline architecture.

Still another object of the invention is to provide a fast Hadamard transform using a serial-pipeline architecture.

A further object of the invention is to provide fast Hadamard transform using a pipeline architecture using only fast added and shifters.

Yet a further object of the invention is to provide a forward normalized fast Hadamard transform and an inverse normalized fast Hadamard transform for providing forward and inverse fast Hadamard transformations without the loss of data quality.

Still a further object of the invention is to provide a fast Hadamard transform having an input stage receiving an input, a processing stage providing a loop back to the input stage, and an output stage providing an output, with output being a transform of the input.

The present invention is directed to a hardware realization of the Fast Hadamard transform (FHT) that reduces a considerable amount of power, weight, and chip area in VLSI designs. The hardware realization can be implemented using two different pipelined designs. The first pipeline design is a parallel-pipelined architecture and the second pipelined design is a serial-pipelined architecture. The pipeline designs implement the improved FHT algorithm for both the unnormalized and normalized Hadamard transforms. Basic digital electronic components of the pipeline designs are adders, shift registers, multiplexers, demultiplexers, and a clock and timing generator.

The parallel-pipelined FHT architecture saves power, weight, and chip area in VLSI circuits, as well as speeds up the transform process. The serial-pipelined FHT architecture saves even more power, weight, and chip area in VLSI circuits in a tradeoff with some reduced process speed. The implementations of both pipeline architectures only require fixed-point shift and add operations. Moreover, for integer input data, the implementation of the FHT for the normalized forward Hadamard transform in both architectures is reversible, namely the normalized inverse Hadamard transform can completely recover the integer input data without any information loss. These and other advantages will become more apparent from the following detailed description of the preferred embodiment.

### BRIEF DESCRIPTION OF THE DRAWINGS

FIG. 1A is a block diagram of a serial-pipeline forward FHT.

FIG. 1B is a block diagram of a parallel-pipeline forward FHT.

FIG. 2A is a block diagram of a unnormalized processing unit for a forward FHT FIG. 2B is a block diagram of a normalized processing unit for a forward FHT.

FIG. 3A is a block diagram of a serial-pipelined inverse FHT.

FIG. 3B is a block diagram of a parallel-pipelined inverse FHT.

FIG. 4A is a block diagram of a unnormalized processing unit for an inverse FHT.

FIG. 4B is a block diagram of a normalized processing unit for an inverse FHT.

FIG. 5A is block diagram of a Fa processing units for both normalized forward and inverse FHT.

FIG. 5B is block diagram of a Fb processing for both normalized forward and inverse FHT.

### DETAILED DESCRIPTION OF THE PREFERRED EMBODIMENT

An embodiment of the invention is described with reference to the figures using reference designations as shown in the figures. The figures show, serial and parallel, forward and inverse, Fast Hadamard transforms (FHTs) of four varieties, each using either normalized or unnormalized processing units (PUs), that in turn, use fast processing units Fa and Fb.

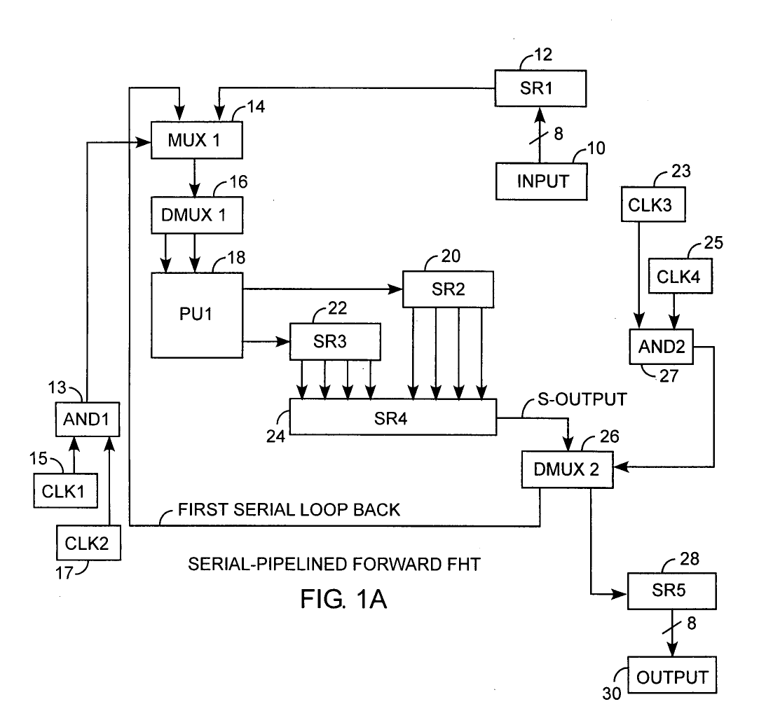

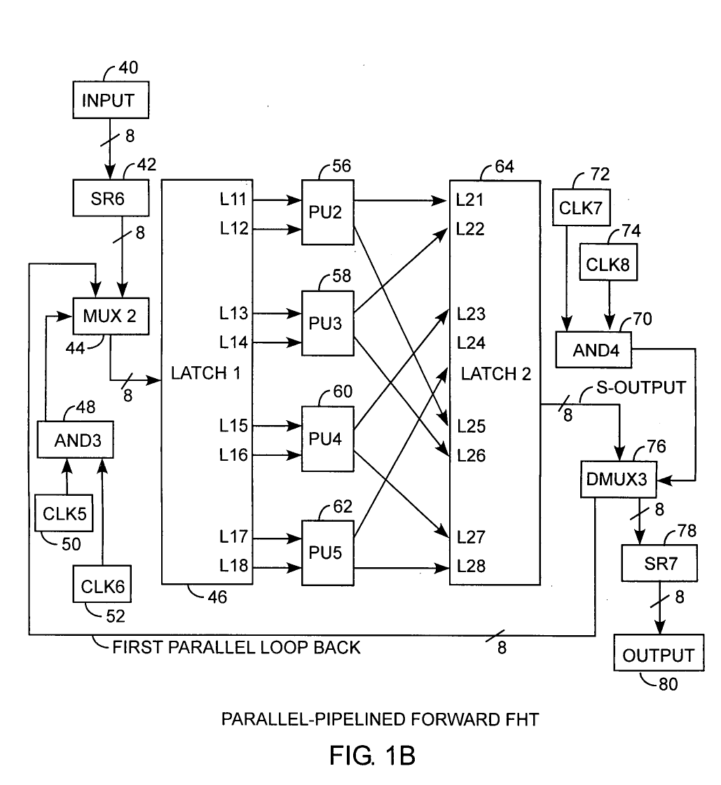

Referring to FIG. 1A, a serial-pipelined forward FHT includes an eight-bit input 10 fed into a first parallel-to-serial shift register 12 shifting serial input data into a first serial multiplexer 14. The multiplexer 14 also receives an S-output feed back through a first serial loop back path. The multiplexer 14 has an output that is fed into the first serial demultiplexer 16 receiving the input as serial data. The multiplexer 14 is clocked by a first AND gate 13 having clocking inputs from a first clock 15 and a second clock 17. The demultiplexer 16 converts serial data into parallel data that is fed into a first 4+4 processing unit 18 providing two four-bit outputs fed into a second four-bit serial-to-parallel shift register 20 and a third four-bit serial-to-parallel shift register 22. The serial-to-parallel shift registers 20 and 24 provide an eight-bit parallel output that is fed into a fourth eight-bit parallel-to-serial shift register 24 for serializing the data into an S-Output. The S-Output is fed into a second serial demultiplexer 26 controlled by an AND gate 27 that is in turned clocked by a third clock 23 and a fourth clock 25. The demultiplexer 26 provides serial feed data on the first serial loop back to the first multiplexer 14 and provides serial output data to a fifth eight-bit serial-to-parallel shift register 28 that provides a serial-pipeline forward FHT eight-bit wide output 30.

Referring to FIG. 1B, a parallel-pipelined forward FHT, a parallel-pipelined forward FHT eight-bit wide input 40 is fed into a sixth eight-bit serial-to-parallel shift register 42 for shifting by eight bits the input 40 into a second eight-bit parallel multiplexer 44 and into a first eight-bit latch 46. The second multiplexer 44 also receives eight-bit words over a first parallel loop back path. A third And gate 48 clocked by a fifth clock 50 and a sixth clock 52, is used for controlling the second multiplexer 44. The first latch 46 provide eight outputs L11-L18 in pairs to respective pairs of processing units including a second 2×2 processing unit 56, a third 2×2 processing unit 58, a fourth 2×2 processing unit 60, and a fifth 2×2 processing unit 62. The PUs 56, 58, 60, and 62 each having a pair of outputs that are cross fed into the inputs L21-28 of a second eight-bit latch 64. The outputs of second PU 56 are cross fed in order of PU2 to L21 and L25, PU3 to L22 and L26, PU4 to L23 and L27, and PU5 to L24 and L28. The output of the second latch 64 is fed as an eight bit word to a third eight-bit multiplexer 76 begin controlled by a fourth And gate 74 and a seventh clock 70 and a eight clock 72 as inputs. The third eight-bit demultiplexer 76 multiplexes the output of the second latch 64 to either the first parallel loop back path to the second multiplexer 44 or to a seventh eight-bit shift register 78 that then provides a parallel-pipeline forward FHT eight-bit output 80.

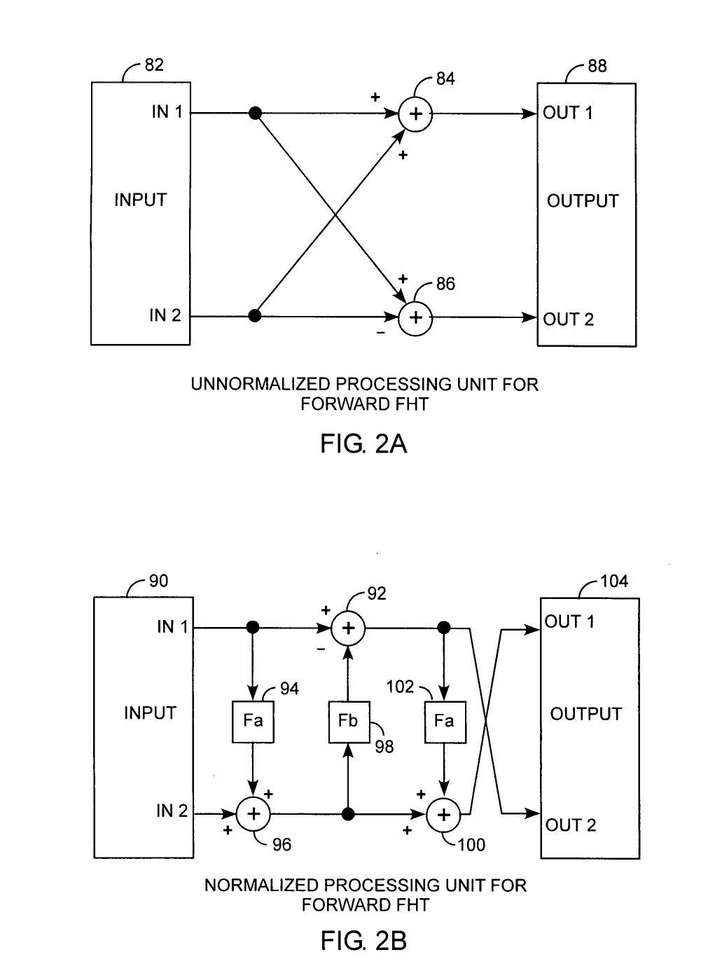

Referring to FIG. 2A, an unnormalized processing unit of a forward FHT includes an unnormalized forward FHT input buffer 82 for providing input In1 and In2 that are cross fed into unnormalized forward FHT summer 84 and an unnormalized forward FHT subtractor 86 for providing a sum as Out1 and a difference as Out2 in an unnormalized forward FHT output buffer 88. The unnormalized processing unit only includes two adders 84 and 86.

Referring to FIG. 2B, a normalized processing unit of a forward FHT includes a normalized forward FHT input buffer 90 having input In1 and In2. The input In 1 is fed to a normalized forward FHT subtractor 92 providing a second output Out2. The first input In1 is also fed to a first normalized forward FHT Fast-a (Fa) processing unit 94 having a first fast output fed into a first normalized forward FHT summer 96. The summer 96 also receives the second input In2 for providing an interim sum. The interim sum is fed into a normalized Fb forward FHT processing unit 98 providing an output that is fed to the subtractor 92. The interim sum is also fed second normalized forward FHT summer 100 providing a final sum as an Out1 output. The output Out2 of the subtractor 92 is fed to a second normalized forward FHT Fa normalized unit 102 for providing a third fast output that is fed into the summer 100 providing the first output Out1. A normalized forward FHT output buffer 104 provides the outputs Out1 an Out2.

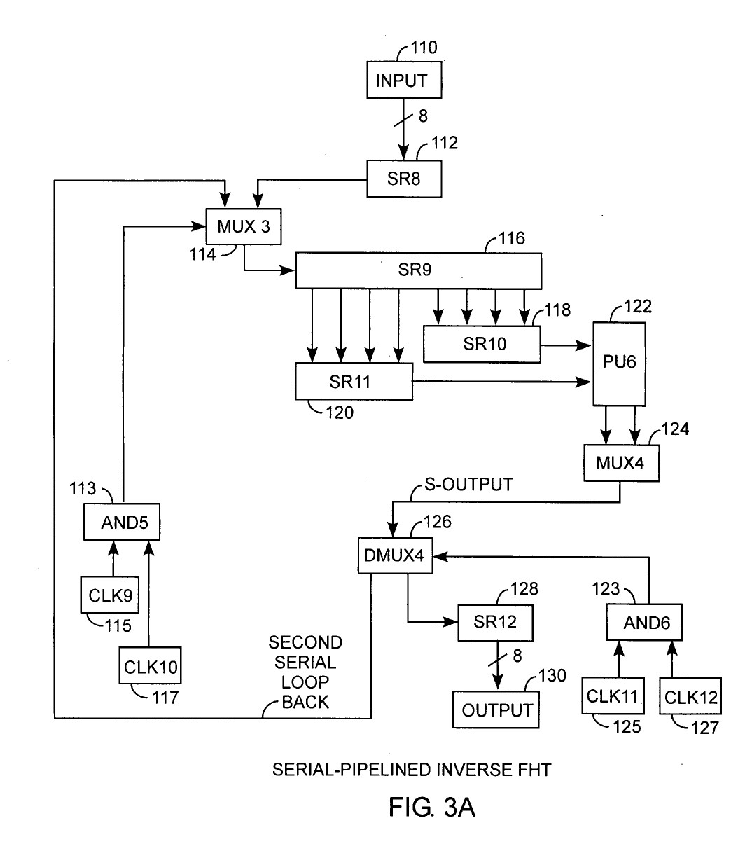

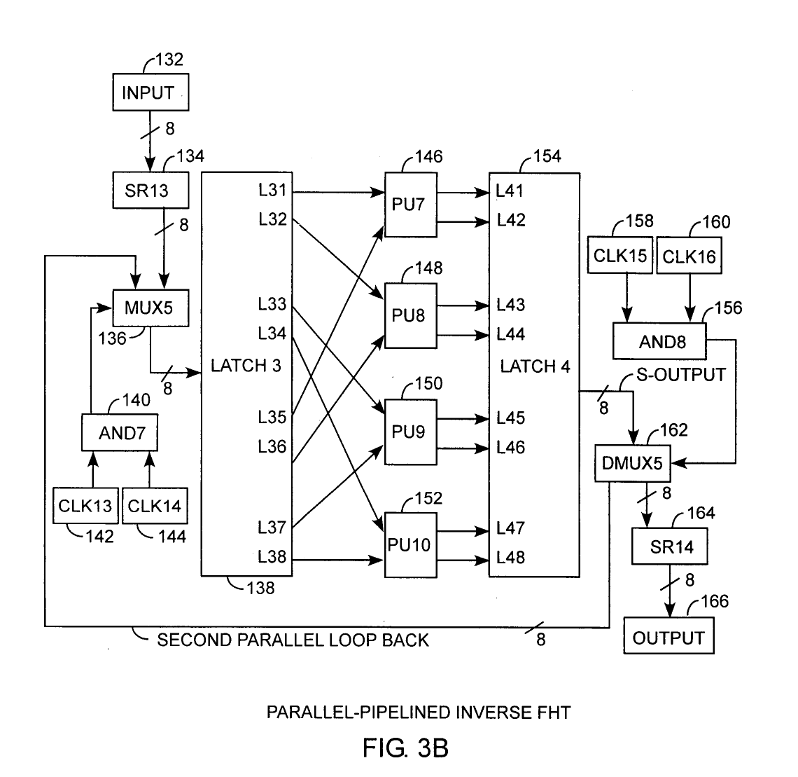

Referring to FIG. 3A, a serial-pipeline inverse FHT includes a serial-pipelined inverse FHT eight-bit input 110 that is fed into an eighth eight-bit shift register 112 providing a serial data output fed into a third serial multiplexer 114. The multiplexer 114 is controlled by a fifth And Gate 113 that is clocked by a ninth clock 115 and a tenth clock 117. The multiplexer 114 receives serial data over a second serial loop back path and provides a serial output to a ninth serial-to-parallel shift register 116 in turn providing parallel output to a tenth four-bit parallel-to-serial shift register 118 and an eleventh four-bit parallel-to-serial shift register 120. The shift registers 118 and 120 provide respective serial inputs to a sixth 2×2 processing unit 122 having two outputs fed into a fourth serial multiplexer 124. The fourth serial multiplexer 124 is clocked by a sixth And gate 123 receiving an eleventh clock 125 and a twelfth clock 127 as inputs. The output of the fourth serial multiplexer 124 is fed to a fourth serial demultiplexer 126 that provides serial data on the second serial loop back path to the third multiplexer 144 a twelfth eight-bit serial-to-parallel shift register 128 for providing a serial-pipelined inverse FHT eight-bit output 130.

Referring to FIG. 3B, a parallel-pipelined inverse FHT includes a parallel-pipeline inverse FHT eight-bit input 132 providing a eight-bit input to a thirteenth eight-bit serial shift register 134 providing a shifted output that is fed to a fifth eight-bit multiplexer 136 that provides a multiplexed input a third eight-bit latch 138. A seventh AND gate 140 is clocked by a thirteenth clock 142 and a fourteenth clock 144 for controlling the fifth eight-bit multiplexer 136. The third eight-bit latch 138 has latched output L31 to L38 that are cross fed into a seventh 2×2 processing unit 146 receiving bits L31 and L35, into an eighth 2×2 processing unit 148 receiving bits L32 and L36, into a ninth 2×2 processing unit 150 receiving bits L33 and L37, and into a tenth 2×2 processing unit 152 receiving bits L34 and L38. The output of the processing units (PU7-10) 146, 148, 150, and 154 are fed into a fourth eight-bit latch 154 having inputs L41-48. An eighth And gate 156 is clocked by a fifteenth clock 158 and a sixteenth clock 160 and is used to control a fifth eight-bit demultiplexer 162. The outputs of the fourth eight-bit latch 154 are fed to the fifth eight-bit demultiplexer 162 for providing a parallel data on a second parallel loop back path to the fifth eight-bit multiplexer 136 and to a fourteenth eight-bit shift register 164 that in turn provides a parallel-pipeline inverse FHT eight-bit output 166.

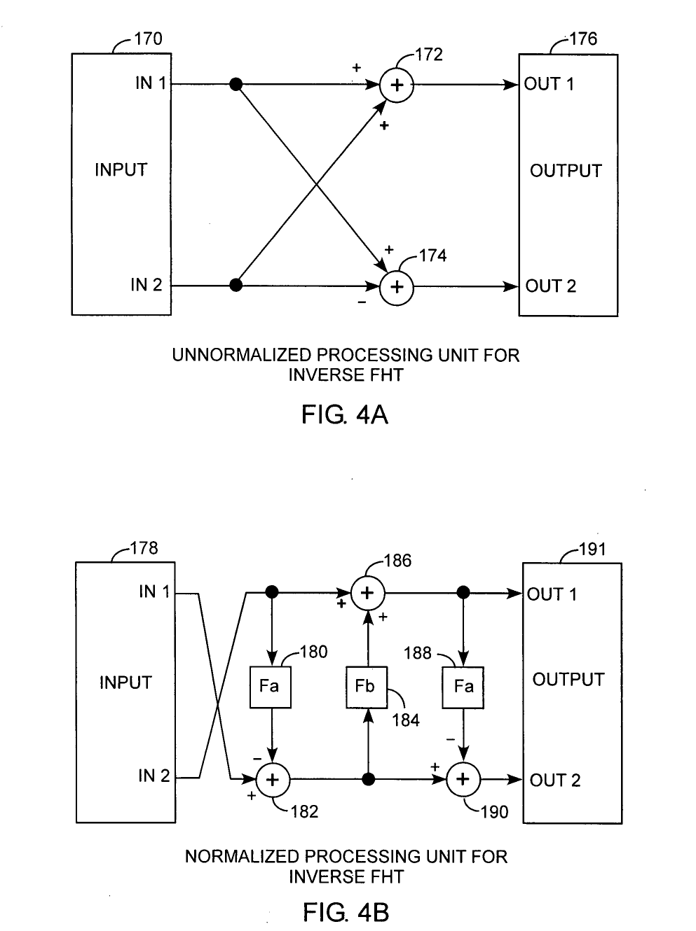

Referring to FIG. 4A, an unnormalized processing unit for an inverse FHT includes an 170 unnormalized inverse FHT input buffer having In1 and In2 inputs fed and cross fed into unnormalized inverse FHT summer 172 providing a sum as an Out1 output and into unnormalized inverse FHT subtractor 174 providing a difference as an Out2 output. The Out1 sum and Out2 difference are fed to an unnormalized inverse FHT output buffer 176.

Referring to FIG. 4B, a normalized processing unit for an inverse FHT includes a normalized inverse FHT input buffer 178 having In1 and In2 inputs. The In2 input is fed to a first normalized inverse FHT Fast-a (Fa) processing unit 180 providing a first fast output as the In1 input is fed to a first normalized inverse FHT subtractor 182 providing an interim difference that is fed to a Fast-b normalized inverse FHT (Fb) processing unit 184 providing a second fast output. The second input In2 and the second fast output are fed to a normalized inverse FHT summer 186 providing a sum as the first output Out1 that is fed to a second normalized inverse FHT Fa normalized unit 188 providing a third fast output. The third fast output from the second normalized inverse FHT Fa normalized unit 188 and the interim difference from the first normalized inverse FHT subtractor 182 are fed to a second normalized inverse FHT subtractor 190 providing a final difference as Out2. The Out1 sum and the Out2 final difference are fed to a normalized inverse FHT output buffer 191 providing the outputs Out1 and Out2.

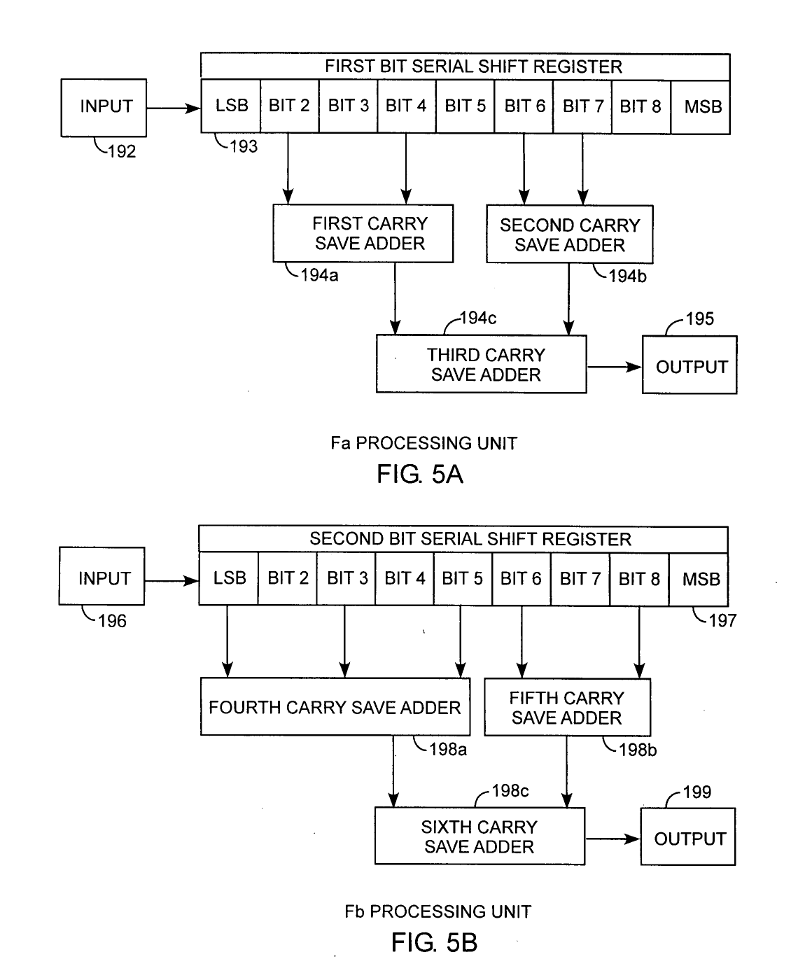

Referring to FIG. 5A, a Fast-a (Fa) processing unit receives an Fa processing unit input 192 that is fed into a first bit-serial shift register 193 of which bits 2 and 4 are fed into a first carry save adder 194a, of which bits 6 and 7 are fed into a second carry save adder 194b. The output of the first carry save adder 194a and the output of the second carry save adder 194b are fed to a third carry save adder 194c. The output of the third carry save adder 194c provide a Fast-a Fa processing unit output 195.

Referring to FIG. 5B, a Fast-b (Fb) processing unit receives an Fb processing unit input 196 that is fed into a second bit-serial shift register 197, of which a LSB, bit 3, and bit 5 are fed into a fourth carry save adder 198a and of which bits 6 and 8 are fed into the a fifth carry save adder 198b. The outputs of the fourth carry save adder 198a and the fifth carry save adder 198b are fed to a sixth carry save adder 198c for providing the Fb processing unit output 199. Referring to all of the Figures, the forward FHTs of FIGS. 1A and 1B use forward processing units of FIGS. 2A and 2B and the inverse FHTs of FIGS. 3A and 3B use inverse processing units of FIGS. 4A and 4B. The forward and inverse processing units of FIGS. 2A, 2B, 2C, and 2D can be unnormalized processing units of FIGS. 2A and 4A or normalized processing units of FIGS. 2B and 4B. The unnormalized processing units of FIGS. 2A and 4A require only effectively two adders whereas the more complex normalized processing units of FIG. 2B and 4B require three effective adders and three fast Fa and Fb processing units of FIGS. 5A and 5B. The normalized and unnormalized processing units function as a lifting stage in the FHTs. The fast Fa and Fb processing units of FIG. 5A and 5B each use only a shift register and three carry adders. As such, the normalized and unnormalized processing units of FIGS. 2A, 2B, 4A, and 4B use only effective adders, carry save adders, and shift registers and are fast without the use of multipliers. The FHTs of FIGS. 1A, 1B, 3A, and 3B use these fast processing units of FIGS. 2A, 2B, 4A, and 4B. In addition, the FHTs use fast multiplexers, demultiplexers, latches, and shift registers with an internal loop back. As such, the FHTs are very fast FHTs using fast components that require low power, low weight, and low chip area, in implementation. The serial FHTs of FIGS. 1A and 3A use a single PU processing unit whereas the parallel FHTs of FIGS. 2B and 3B use a bank of PU processing units, and in the preferred form, use four PU processing units. The forward FHTs of FIGS. 1A and 3A use straight feeds of the PU inputs and outputs whereas the inverse FHTs of FIGS. 2B and 4B use cross feed of the PU inputs and outputs for inverse operation. As such, the FHTs provide for forward and inverse, parallel and serial, normalized and unnormalized, fast, Hadamard transformations.

The FHTs of FIG. 1A, 1B, 3A, and 3B are characterized as having an input stage for multiplexing an input and a loop back signal, having a processing stage comprising a processing unit for providing the loop back signal, and having an output stage for providing a transformed output from the loop back signal. The input stage includes a multiplexer for multiplexing the input signal and the loop back signal into a multiplexed signal that is fed to the processing stage. The processing stage includes a PU processing unit for generating the loop back signal from the multiplexed signal. The output stage includes a demultiplexer for demultiplexing the loop back signal to the multiplexer stage and for generating a transformed output.

The FHTs use a single PU processing stage. The serial-pipeline FHTs use a PU processing unit in the PU processing stage. The parallel-pipeline FHTs also use one stage PU processing unit stage with PU processing units being repeatedly in a bank of PU processing units log₂(N) times. The parallel-pipeline FHT for the unnormalized FHT having eight inputs, is constructed based on the recursive algorithm for the unnormalized Hadamard transform U_{N}=[S_{N}]^{K} for K=log₂(N). The parallel-pipeline FHT for the normalized FHT having eight inputs, is constructed based on the recursive algorithm for the normalized Hadamard transform H_{N}=[R_{N}]^{K} for K=log₂(N). The low power FHTs use a few 2×2 HT to compute an N×N HT. R is the Haar transform. The low power FHT is defined by H_{N}=[R_{N}]^{k}, where N=2^{k}. For example, the elementary operator in R₈ is H₂, which is given by the H₂ equation.

$${H}_{2} = \frac{1}{\sqrt{2}} [ \begin{matrix}1 & 1 \\ 1 & - 1\end{matrix} ] = [ \begin{matrix}0 & 1 \\ 1 & 0\end{matrix} ] [ \begin{matrix}1 & 0 \\ a & 1\end{matrix} ] [ \begin{matrix}1 & - b \\ 0 & 1\end{matrix} ] [ \begin{matrix}1 & 0 \\ a & 1\end{matrix} ]$$

In the H₂ equation, a=√2−1, b=1/√2. Using only integer fast arithmetic operations but without slow multiplications, the H₂ equation is converted into the following lifting operations.

$${y}_{2}^{( 1 )} = {y}_{2}^{( 0 )} + ⌊ {ay}_{1}^{( 0 )} ⌋$$

$${y}_{1}^{( 1 )} = {y}_{1}^{( 0 )} - ⌊ {by}_{2}^{( 1 )} ⌋$$

$${y}_{2}^{( 2 )} = {y}_{2}^{( 1 )} + ⌊ {ay}_{1}^{( 1 )} ⌋$$

The final lifting values of y₁ and y₂ are swapped after lifting. With very accurate approximations, the rational value of -a- is chosen as (32+16+4+1)/128 and the rational value of -b- is (1+a)/2 such that -a- and -b- can be calculated by fast binary shift and add operations. The implementation of the nonlinear lifting operation for the normalized forward Hadamard transform also only uses fast arithmetic operations without multipliers. The nonlinear lifting operation is completely lossless, in that, the inverse lifting can completely recover the integer input data. The implementation of the inverse lifting operation for the normalized inverse Hadamard transform also only uses fast arithmetic operations without multipliers. Consequently, for integer input data, the implementation of the FHT for the normalized forward FHT Hadamard transform is reversible, in that, the normalized inverse Hadamard transform can completely recover the integer input data without any loss. The implementation of the FHT for the normalized inverse FHT is the same for the normalized forward FHT except that the input and output are simply swapped.

Advantages of the parallel-pipelined architectures for the unnormalized FHT and normalized FHT are that both of the parallel-pipelined FHT architectures use much less chip area in VLSI designs, that the FHTs only use fixed-point shift and add arithmetic operations, and that the FHTs do not need multiplications and memory access during transform process. Consequently, the parallel-pipelined FHTs save power, weight, and area in VLSI circuits, and speed up the transform process. For example, the decrease in estimated power consumption is 6 to 1 for N=32. So is the estimated transform delay for fast transformation. The Hadamard transform is used for transforming an input into a transformed output. The Hadamard transform uses an input stage for multiplexing the input and a loop back into a multiplexed output. The Hadamard transform uses a processing stage comprising one or more processing units of fast components for transforming the multiplexed output into an S-output then uses the one or more processing units consisting of fast components. Hadamard transform also has an output stage for demultiplexing the S-output to the loop back and to the transformed output. When the Hadamard transform is a serial transform, only one processing unit is used. When the Hadamard transform is a parallel transform, processing units are a bank of processing units coupled to input and output latches. The Hadamard transform can be a normalized or unnormalized transform. When the Hadamard transform is unnormalized, the one or more processing units are unnormalized Haar transform processing units. When the Hadamard transform is normalized, the one or more processing units are normalized Hadamard transform processing units. In all cases of serial and parallel, forward and inverse, and normalized and unnormalized, an S-output is generated each K recursive loop backs of the S-output to the input stage. The processing stage perfects an S transform providing the S-output. After the K recursive loop backs of the S-output, the final S-output becomes a Hadamard transform output.

The FHTs have many applications. For example, in hand-held wireless communication devices, the premier requirement is to use the least amount of power, weight, and chip area in VLSI circuits in exchange for very fast processing speed. For such applications, a serial-pipelined architecture for both the unnormalized FHT and normalized FHT is preferred, such as an FHT using only one PU processing unit for either the unnormalized Hadamard transform or normalized Hadamard transform. The commercial use of the FHTs is can be for portable wireless communication terminals, such as hand-held cellular phones for the advantageous features of low power and small size. Those skilled in the art can make enhancements, improvements, and modifications to the invention, and these enhancements, improvements, and modifications may nonetheless fall within the spirit and scope of the following claims.

What is claimed is:

1. A Hadamard transform from transforming an input into a transformed output, the transform comprising,
an input stage for multiplexing the input and a loop back into a multiplexed output,
a processing stage comprising one or more processing units for transforming the multiplexed output into an S-output, the one or more processing units consisting of fast components, and
an output stage for demultiplexing the S-output to the loop back and to the transformed output.

2. The transform of claim 1 wherein,
the fast components are selected from the group consisting of shift registers and adders, and
the transform is a fast transform.

3. The transform of claim 1 wherein,
the transform is implemented by fast components selected from the group consisting of shift registers, adders, multiplexers, and demultiplexers, and
the transform is a fast transform.

4. The transform of claim 1 wherein,
the transform is implemented as serial-pipelined forward transform,
the one or more processing units is one processing unit,
the multiplexed output is a serial output,
the processing stage comprises a demultiplexer for. demultiplexing the serial output into a parallel output,
the one processing unit is a forward processing unit for receiving the parallel output and providing parallel processed outputs,
the processing stage comprises a shifter for shifting the parallel processed outputs into the S-output being a serial output, and
the output stage comprises a demultiplexer for demultiplexing the S-output to the loop back and to a serial output.

5. The transform of claim 1 wherein,
the transform is implemented as parallel-pipelined forward transform,
the one or more processing units is a plurality of processing units,
the multiplexed output is a parallel output,
the processing stage comprises a input latch for storing the parallel output,
the one or more processing units is a bank of forward processing units for receiving the parallel output and providing parallel processed outputs,
the processing stage comprises an output latch for cross fed receiving of the parallel processed outputs and storing the parallel processed outputs as a cross fed output as the S-output being a parallel output, and
the output stage comprises a demultiplexer for demultiplexing the S-output to the loop back and to a parallel output.

6. The transform of claim 1 wherein,
the transform is implemented as serial-pipelined inverse transform,
the one or more processing units is one processing unit,
the multiplexed output is a serial output,
the processing stage comprises a shifter for shifting the serial output into a parallel output,
the one processing unit is a forward processing unit for receiving the parallel output and providing parallel processed outputs,
the processing unit comprises a multiplexer for converting the parallel processed outputs into the S-output being a serial output, and
the output stage comprises a demultiplexer for demultiplexing the S-output to the loop back and to a serial output.

7. The transform of claim 1 wherein,
the transform is implemented as parallel-pipelined inverse transform,
the one or more processing units is a plurality of processing units,
the multiplexed output is a parallel output,
the processing stage comprises a input latch for storing the parallel output,
the one or more processing units is a bank of inverse processing units for cross fed receiving the parallel output and providing parallel processed outputs,
the processing stage comprises an output latch for storing the parallel processed outputs as the S-output being a parallel output, and
the output stage comprises a demultiplexer for demultiplexing the S-output to the loop back and to a parallel output.

8. The transform of claim 1 wherein,
the transform is a forward transform,
the processing unit is an unnormalized processing unit,
the processing unit receives two inputs and provides two outputs, and
the processing unit consists of an adder and a subtractor,
the two inputs are cross fed into to the adder and the subtractor respectively providing the two outputs.

9. The transform of claim 1 wherein,
the transform is a forward transform,
the one or more processing units is a normalized processing unit,
the processing unit receives two inputs and provides two outputs,
the processing unit feeds the two inputs into a lifting stage consisting of three fast processing units, two adders, and one subtractor,
the subtractor provides one of the two outputs, and
one of the two adders provides another one of the two outputs.

10. The transform of claim 1 wherein,
the transform is an inverse transform,
the processing unit is an unnormalized processing unit,
the processing unit receives two inputs and provides two outputs, and
the processing unit consists of two adders, and
the two inputs are cross fed into the two adders respectively providing the two outputs.

11. The transform of claim 1 wherein,
the transform is an inverse transform,
the one or more processing units is a normalized processing unit,
the normalized processing unit receives two inputs and provides two outputs,
the normalized processing unit feeds the two inputs into a lifting stage consisting of three fast processing units, two adders, and one subtractor,
the subtractor provides one of the two outputs, and
one of the two adders provides another one of the two outputs.

12. The transform of claim 1, wherein,
the one or more processing units comprise a fast processing unit, and
the fast processing unit comprises a shift register and carry save adders, the shift register providing bits to the carry save adders for adding the bits.

13. The transform of claim 1 wherein,
the transform is a parallel-pipelined transform,
the one or more processing units is a bank of the processing units,
the processing units are 2×2 Hadamard transform processing units,
the S-output is a parallel output having N bits, and
the bank of processing unit includes K=log₂(N) processing units.

14. The transform of claim 1 wherein,
the transform is parallel-pipelined transform,
the one or more processing units is a bank of the processing units,
the processing units are 2×2 Hadamard transform processing units,
the S-output is a parallel output having N bits,
the bank of processing units includes K=log₂(N) processing units, and
the transform is an normalized Hadamard transform H_{N}=[S_{N}]^{K} where S_{N} is a normalized S transform.

15. The transform of claim 1 wherein,
the transform is parallel-pipelined transform,
the one or more processing units is a bank of the processing units,
the processing units are 2×2 Haar transform processing units,
the S-output is a parallel output having N bits,
the bank of processing units are K=log₂(N) processing units,
the transform is an unnormalized Hadamard transform U_{N}=[S_{N}]^{K} where S_{N} is an unnormalized S transform, and
the transform output is generated by recursive feed back of the S-output.

16. The transform of claim 1 wherein,
the transform is parallel-pipelined transform,
the one or more processing units is a bank of the processing units,
the processing units are 2×2 Hadamard transform processing units,
the S-output is a parallel output having N bits,
the bank of processing units are K=log₂(N) processing units,
the transform is an normalized Hadamard transform H_{N}=[S_{N}]^{K} where S_{N} is a normalized S transform,
the transform output is generated by a recursive feed back of the S-output,
the transform is a forward transform,
each of the processing units is a normalized processing unit,
each of the processing units receives two inputs and provides two outputs,
each of the processing units feeds the two inputs into a lifting stage consisting of two fast-a processing units, one fast-b processing units, two adders, and one subtractor,
the subtractor provides one of the two outputs, and
one of the two adders provides another one of the two outputs,
the lifting stage is defined by “a” and “b” parameters where N=8, a=(32+16+4+1)/128, and b=(1+a)/2.

17. The transform of claim 1 wherein,
the one or more processing units are one or more normalized processing units, and
the one or more normalized processing units are normalized Hadamard transform processing units.

18. The transform of claim 1 wherein,
the one or more processing units are one or more unnormalized processing units, and
the one or more unnormalized processing units are unnormalized Haar transform processing units.
